(19) United States
(12) Patent Application Publication
(10) Pub. No.: US 2026/0110373 A1
(43) Pub. Date: Apr. 23, 2026

(54) Laser Alignment Tool for Precise Flange Fit-Up in Oil and Gas Applications

(71) Applicant: Aaron Rodriguez, Beaumont, TX (US)

(72) Inventor: Aaron Rodriguez, Beaumont, TX (US)

(21) Appl. No.: 19/359,454

(22) Filed: Oct. 15, 2025

Related U.S. Application Data
(60) Provisional application No. 63/710,830, filed on Oct. 23, 2024.

(51) Int. Cl. F16L 1/10

(52) U.S. Cl. CPC F16L 1/10

(57) ABSTRACT

A laser alignment tool for flange fit-up includes tapered centering nuts that seat in flange bolt holes, a mounting bolt to secure the nuts, and a connector rod extending through the nuts. A yoke bracket at the laser end carries a rotatable laser housing with an integrated laser projection system. A manual actuator controls a clamping head that selectively locks the laser housing orientation. Multiple bubble levels on the nuts, rod, and housing provide comprehensive leveling verification. The tool projects a visible laser line across flange surfaces to provide precise visual alignment reference for positioning flanges relative to corresponding components, eliminating inaccuracies of manual alignment techniques while enabling single-operator use with 360-degree rotational adjustment capability for complex angular alignments in oil and gas applications.

### CROSS REFERENCE TO RELATED APPLICATIONS

This application claims the benefit and priority of U.S. Application Ser. No. 63/710,830, which was filed on Oct. 23, 2024, and is hereby incorporated by reference including all references and appendices cited therein for all purposes as if fully set forth herein.

### FIELD

The present disclosure relates to laser alignment tools for flange fit-up in industrial applications, particularly in oil and gas operations where precise alignment of flanges is required for establishing reliable connections in piping systems.

### BACKGROUND

In the oil and gas industry, alignment of flanges is used for establishing reliable connections in piping systems, particularly in downhole applications. Historically, the alignment process has involved manual techniques, including the use of straight edges, plumb lines, or measurement tools to ensure that flanges are properly positioned before they are bolted into place. Workers typically use mechanical fixtures inserted into flange bolt holes to align the flange with another component, such as an elbow or an adjoining pipe. These methods often require several workers to hold straight edges or stretch strings across flanges to confirm alignment.

While these traditional techniques are common, they are subject to inaccuracies and inefficiencies. Misalignment may result in improper sealing between flanges, potentially leading to leakage, increased safety risks, and costly corrections. Moreover, the manual alignment process can be time-consuming, especially when adjustments are needed in multiple directions to rotate the flange into the correct orientation.

### SUMMARY

A laser alignment tool for flange fit-up comprises a plurality of tapered centering nuts, each tapered centering nut having a tapered outer surface sized to seat in a flange bolt hole and a through-bore sized to slidably receive a connector rod. A mounting bolt extends through opposed tapered centering nuts of the plurality of tapered centering nuts and is configured, when tightened, to draw the opposed tapered centering nuts toward one another. A connector rod extends through the through-bores of the plurality of tapered centering nuts. A compression nut engages with the connector rod at a flange mounting end and is operable to prevent sliding of the connector rod relative to the plurality of tapered centering nuts. A yoke bracket positions at a laser mounting end of the connector rod. A manual actuator couples rotatably to the yoke bracket. A threaded adjustment shaft extends from the manual actuator through the yoke bracket. A clamping head attaches to the threaded adjustment shaft and has a contoured engagement surface configured to interface with the connector rod. A laser housing is carried by the yoke bracket and rotatable relative to the connector rod when the clamping head is disengaged. A laser projection system disposes within the laser housing and is configured to emit a visible laser line across a flange surface.

The flange alignment apparatus includes a flange mounting assembly including tapered centering nuts sized to engage flange bolt holes and a mounting bolt configured to secure the tapered centering nuts to a flange, a support rod extending from the flange mounting assembly, a laser mounting assembly positioned on the support rod and including a bracket assembly with a clamping mechanism operable to selectively lock and release rotational movement of a laser housing, the laser housing rotatably supported by the laser mounting assembly, and a laser source within the laser housing configured to project a coherent beam for flange alignment, wherein disengaging the clamping mechanism permits 360-degree rotation of the laser housing relative to the support rod.

A method for aligning a flange comprises inserting tapered centering nuts into opposed bolt holes of a flange, each tapered centering nut having a through-bore, securing the tapered centering nuts to the flange using a mounting bolt, positioning a support rod through the through-bores of the tapered centering nuts, securing the support rod in position using a compression mechanism, mounting a laser housing on the support rod using a bracket assembly with a clamping mechanism, projecting a laser line from the laser housing across a flange surface to create a visual alignment reference, positioning the flange relative to a corresponding component using the laser line as an alignment guide, and locking the laser housing orientation when desired alignment is achieved.

### BRIEF DESCRIPTION OF THE DRAWINGS

FIG. 1 illustrates an example laser alignment tool showing the yoke bracket assembly with clamping mechanism and laser housing mounted on a connector rod.

FIG. 2A shows the flange mounting end with tapered centering nuts positioned in one pair of diametrically opposed flange bolt holes with the mounting bolt extending through both nuts to create axial clamping force.

FIG. 2B depicts the flange mounting assembly rotated ninety degrees from FIG. 2A, showing a second pair of tapered centering nuts positioned in another set of diametrically opposed bolt holes on the same flange.

FIG. 3 shows a top-down view of the alignment device with the laser creating a cross-pattern reference for complex alignments.

FIG. 4 illustrates the tapered centering nuts in detail showing their conical configuration and bubble level integration.

FIG. 5 depicts the complete yoke bracket assembly with the clamping mechanism and ball-head tilt mount for securing laser housing orientation.

FIG. 6 shows the laser alignment tool mounted on a flange assembly in operational configuration.

FIG. 7 illustrates a flow diagram showing the method steps for flange alignment using the laser tool.

### DETAILED DESCRIPTION

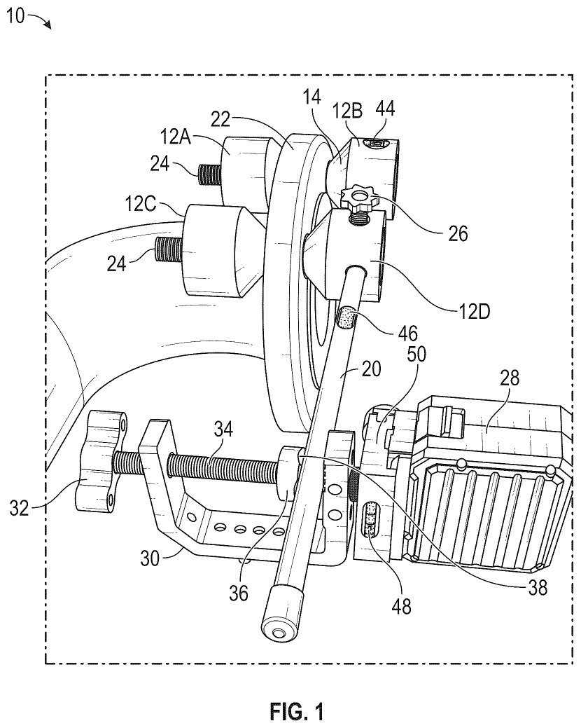

FIG. 1 illustrates the laser alignment tool 10 in its assembled configuration, showing the integration of the flange mounting components, support structure, and laser projection system. The laser alignment tool 10 includes a plurality of tapered centering nuts 12A, 12B, 12C, and 12D, each constructed with a tapered outer surface 14 that engages with flange bolt holes and an axial through-bore 18 that receives the connector rod 20. The flange 22 serves as the primary mounting interface for the tool, providing the structural attachment point through its bolt hole pattern. A mounting bolt 24 creates the mechanical clamping mechanism that secures opposed pairs of tapered centering nuts to the flange structure. The compression nut 26 threads onto the connector rod 20 at the flange mounting end, preventing axial movement of the rod relative to the secured centering nuts.

The laser housing 28 encloses a laser projection system and mounts to the yoke bracket 30, which positions at the opposite end of the connector rod 20 from the flange mounting assembly. The yoke bracket 30 provides a C-shaped or U-shaped cradle that partially surrounds the connector rod 20 while supporting the laser housing 28 and enabling controlled rotational adjustment. A manual actuator 32 threads into or otherwise couples rotatably with the yoke bracket 30, connecting mechanically to a threaded adjustment shaft 34 that translates rotational input into linear clamping motion. The clamping head 36 attaches to the distal end of the threaded adjustment shaft 34 and incorporates a contoured engagement surface 38 shaped to grip the cylindrical profile of the connector rod 20. When the manual actuator 32 rotates in the tightening direction, the threaded adjustment shaft 34 advances the clamping head 36 toward the connector rod 20 until the contoured engagement surface 38 presses against the rod with sufficient force to prevent rotation of the laser housing 28 relative to the rod.

The laser housing 28 contains a self-contained laser unit that emits a visible laser line 42 extending across the work area to provide visual alignment reference. Bubble levels 44, 46, and 48 integrate into various components throughout the tool to enable leveling verification during setup and alignment operations. Bubble level 44 may mount within or on one of the tapered centering nuts, bubble level 46 may position on the yoke bracket or connector rod, and bubble level 48 may integrate into the laser housing mounting interface. In the embodiment shown in FIG. 1, the laser housing 28 couples to the yoke bracket 30 through a shoe track 50, which provides a rail-type interface that permits rotational movement while maintaining alignment between the housing and bracket. The bubble level 48 integrates into the shoe track 50 to indicate orientation of the laser housing relative to the horizontal plane.

The tapered centering nuts 12A, 12B, 12C, and 12D each incorporate a conical or frusto-conical outer profile designed to engage precisely with the cylindrical geometry of standard flange bolt holes. The taper angle of the outer surface 14, typically ranging from 15 to 45 degrees relative to the central axis, creates a self-centering wedge interface when inserted into a bolt hole. As each nut advances into its respective bolt hole, the tapered surface 14 contacts the cylindrical wall of the hole progressively, with initial contact occurring at the smaller-diameter end of the taper and progressively increasing contact area as insertion depth increases. This geometry automatically centers the nut concentrically within the bolt hole while accommodating manufacturing tolerances and minor irregularities in the hole diameter or surface finish.

Each tapered centering nut includes the through-bore 18 extending axially through its center, dimensioned to receive the connector rod 20 with sufficient clearance to permit sliding assembly. The through-bore 18 maintains a straight cylindrical geometry aligned coaxially with the centerline of the tapered outer surface 14, ensuring that when multiple nuts seat in their respective bolt holes, their through-bores 18 align to create a continuous passage for the connector rod 20. The wall thickness between the through-bore 18 and the tapered outer surface 14 provides structural strength to resist clamping forces during installation and operational loads during alignment procedures.

The tapered centering nuts may be manufactured from high-strength materials including carbon steel, alloy steel, stainless steel grades such as 304 or 316, aluminum alloys, or other metals selected for their mechanical properties, corrosion resistance, and weight characteristics. Surface treatments such as black oxide coating, zinc plating, anodizing, or specialized corrosion-resistant finishes enhance durability in harsh industrial environments including offshore platforms, chemical processing facilities, or marine applications. Alternative taper configurations include straight conical profiles with constant taper angle, curved or parabolic profiles that modify the contact pressure distribution, or stepped configurations with multiple taper angles to accommodate different bolt hole specifications.

The through-bore 18 diameter typically ranges from 0.4 to 0.6 inches for connector rods in the half-inch diameter range, though the dimensions scale proportionally for different rod sizes. Some embodiments incorporate internal geometries within the through-bore 18 including keyways, flats, or splines that engage with corresponding features on the connector rod 20 to prevent relative rotation while still permitting axial sliding during assembly. Other embodiments maintain a smooth cylindrical bore to maximize assembly flexibility and permit full 360-degree rotational adjustment of the laser housing without mechanical interference.

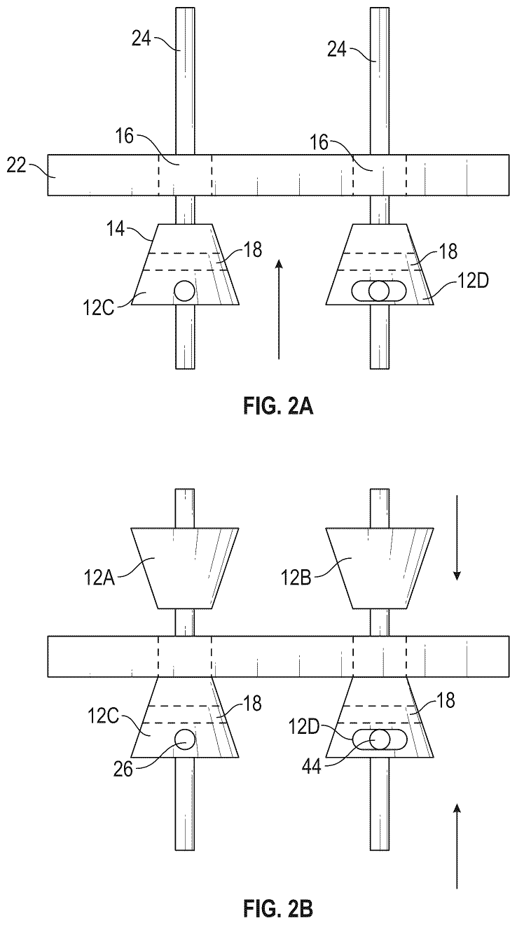

FIG. 2A shows the flange mounting end of the laser alignment tool with tapered centering nuts 12A and 12B installed in a first pair of diametrically opposed bolt holes 16 of flange 22. The flange 22 represents a standard industrial flange configuration with multiple bolt holes 16 arranged in a circular pattern around the flange periphery at a defined bolt circle diameter. In typical applications, the flange 22 includes four, six, eight, or more equally-spaced bolt holes depending on the flange size, pressure rating, and pipe diameter. For the present application, four bolt holes arranged at 90-degree intervals provide the most common configuration, though the tool adapts to other bolt patterns.

The tapered centering nut 12A inserts into one bolt hole 16 on a first side of the flange 22, with its tapered outer surface 14 engaging the cylindrical wall of the hole. The nut advances into the hole until the taper geometry seats firmly, creating a friction-fit wedge interface that resists radial movement. The tapered centering nut 12B inserts into the diametrically opposed bolt hole 16 on the opposite side of the flange 22, positioning directly across from nut 12A such that their through-bores 18 align coaxially across the flange thickness and central opening.

The mounting bolt 24 extends through the through-bore 18 of nut 12A, crosses the central opening of flange 22, and extends into the through-bore 18 of nut 12B. The mounting bolt 24 includes external threads along at least a portion of its length, with these threads engaging internal threads formed within the through-bore of at least one of the opposed nuts. In one configuration, nut 12A includes internal threads within its through-bore while nut 12B has a smooth through-bore, allowing the bolt 24 to pass freely through nut 12B and thread into nut 12A. In an alternative configuration, both nuts include internal threads, with the bolt threading into one nut from each end or featuring threads in opposite hands to create bidirectional draw when rotated.

When the mounting bolt 24 rotates in the tightening direction, the threaded engagement generates axial tension in the bolt that pulls nuts 12A and 12B toward one another across the flange thickness. This axial force has two effects: first, it compresses the nuts against the respective faces of the flange adjacent to their bolt holes, creating clamping force that stabilizes the assembly; second, it increases the radial force between the tapered outer surfaces 14 and the bolt hole walls, enhancing the wedge grip and further resisting any tendency for the nuts to shift position. The combined axial and radial clamping creates a rigid, stable mounting platform that withstands vibration, mechanical shock, and the operational loads imposed during flange positioning.

The through-bores 18 of nuts 12A and 12B, when aligned, create a continuous passage with a common centerline that extends diametrically across the flange 22. This aligned passage receives the connector rod 20, establishing the geometric reference axis for the entire laser alignment system. The positioning of this axis through diametrically opposed bolt holes ensures that the connector rod 20 extends perpendicular to the flange face when the flange is properly oriented, or at a known angular relationship when the flange requires tilted positioning.

The interface between each tapered outer surface 14 and its respective bolt hole 16 creates a three-point or multi-point contact pattern around the circumference of the hole, distributing clamping loads and preventing stress concentration that could damage the flange. This distributed loading proves particularly important for aluminum flanges or flanges with corrosion-affected bolt holes, where localized high stresses could cause material deformation or failure. The tapered geometry also accommodates bolt holes with dimensional variations, surface imperfections, or slight ovalization, maintaining secure mounting across a range of field conditions.

FIG. 2B depicts the flange mounting assembly from a viewing angle rotated 90 degrees from FIG. 2A, revealing tapered centering nuts 12C and 12D installed in a second pair of diametrically opposed bolt holes 16 of the same flange 22. In typical practice, a four-bolt-hole flange accommodates two perpendicular pairs of opposed bolt holes. The first pair at 0 and 180 degrees receives nuts 12A and 12B as shown in FIG. 2A, while the second pair at 90 and 270 degrees receives nuts 12C and 12D as shown in FIG. 2B. This four-nut configuration provides enhanced stability and load distribution compared to a two-nut arrangement, particularly valuable when the tool experiences side loads, moments, or vibration during field use.

The mounting bolt 24 extends through the through-bores of nuts 12C and 12D using the same clamping mechanism described for nuts 12A and 12B. When tightened, the bolt generates axial tension that draws nuts 12C and 12D toward one another, compressing their tapered surfaces 14 radially outward against the cylindrical walls of their respective bolt holes 16. The four-nut configuration creates a stable mounting platform with resistance to rotation, tilting, or shifting in any direction within the plane of the flange.

The four-nut arrangement also ensures that the connector rod 20 receives support from all four through-bores, creating a rigid, well-constrained interface that prevents the rod from cocking, bending, or shifting laterally. Each through-bore acts as a bearing surface guiding the rod, with the combined effect of four aligned bores creating a precise cylindrical passage that maintains the rod's perpendicular relationship to the flange face.

Alternative embodiments employ only two opposed nuts for lighter-duty applications or when only two bolt holes are accessible due to obstruction from adjacent equipment or piping. Other embodiments use six or eight nuts arranged in three or four opposed pairs for heavy flanges or high-vibration environments. The modular nature of the tapered nut design permits field selection of the appropriate number of nuts based on the specific application requirements and available bolt hole access.

The connector rod 20 extends through the aligned through-bores 18 of all installed tapered centering nuts, serving as the primary structural member connecting the flange mounting assembly to the laser mounting assembly. The rod 20 typically comprises a solid cylindrical bar manufactured from forged or rolled steel, though stainless steel, aluminum, titanium, or composite materials may substitute depending on the application's corrosion resistance, weight, or strength requirements. Standard rod diameters range from ⅜ inch to ⅝ inch, with half-inch diameter representing a common mid-range selection balancing strength against weight and handling convenience.

The rod 20 length varies to accommodate different flange thicknesses, clearance requirements behind the flange face, and desired standoff distance for the laser projection system. Typical lengths range from 12 inches to 24 inches, though custom lengths address specific installation geometries. Shorter rods suit compact flanges and close-quarters installations, while longer rods position the laser housing at greater distance from the flange for improved visibility or to clear obstructions.

The rod's circular cross-section permits 360-degree rotation of the laser housing 28 when the clamping mechanism releases, enabling infinite angular positioning of the projected laser line. Alternative cross-sections including hexagonal, square, or rectangular profiles provide indexed positioning or prevent rotation, though these sacrifice the full rotational adjustment capability that characterizes the preferred embodiment. Some rods incorporate surface treatments including hard chrome plating, anodizing, or specialized low-friction coatings to reduce wear during repeated clamping cycles and enhance corrosion resistance.

The rod 20 may include graduated markings, scales, or depth indicators along its length to assist with positioning the laser housing at specific distances from the flange face. Some embodiments incorporate a knurled or textured grip section near one end to facilitate handling during assembly. Other embodiments thread one or both ends to accept accessories, extensions, or alternative mounting hardware.

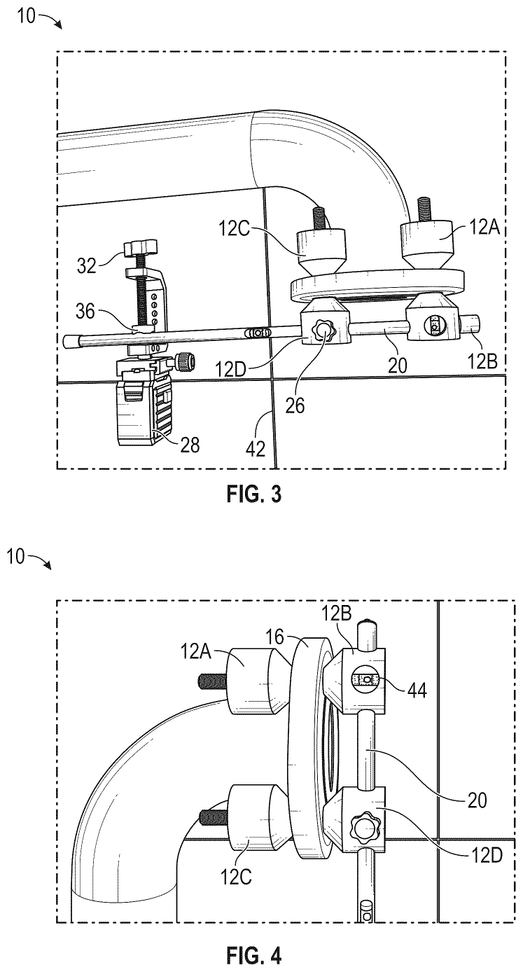

FIG. 3 presents a top-down view of the laser alignment tool 10 in operational configuration, showing the laser line 42 projected from the laser housing 28 across the work area. This overhead perspective illustrates how the tool creates visual alignment references for positioning flanges relative to adjacent components such as elbows, tees, valves, or mating flanges. The laser line 42 extends as a thin, highly visible line of coherent light projecting across distances appropriate for typical flange alignment tasks in industrial piping systems.

In the configuration shown, the laser unit generates a cross-pattern consisting of two perpendicular laser lines intersecting at the laser housing position. This cross-pattern provides simultaneous reference in two orthogonal directions, enabling alignment verification for complex geometries requiring multi-axis positioning. The horizontal line of the cross establishes a level reference, while the vertical line provides a plumb or perpendicular reference. Alternatively, both lines may orient at specific angles to match the geometry of the components being aligned.

The cross-pattern capability proves particularly valuable when aligning flanges that must match not only the axial direction of an adjoining pipe but also rotational clocking to align bolt holes or orient internal features such as flow restriction orifices, temperature sensor ports, or pressure tap connections. By projecting reference lines in two directions simultaneously, the tool enables single-setup alignment that would otherwise require multiple repositioning cycles or additional tools.

The laser housing 28 rotates about the connector rod 20 to orient the cross-pattern at any desired angle, accommodating non-orthogonal alignment requirements or adapting to the specific geometry of the installation. When the manual actuator 32 loosens to disengage the clamping head 36 from the connector rod 20, the housing 28 rotates freely through 360 degrees with minimal friction, permitting rapid angular adjustment. Once the desired orientation is achieved, tightening the actuator 32 locks the housing in position, maintaining the laser line orientation throughout the alignment and installation process.

The compression nut 26 threads onto the connector rod 20 at the flange mounting end, positioning adjacent to the tapered centering nuts after the rod 20 inserts through their aligned through-bores. The compression nut 26 features internal threads matching the external threads on the rod 20, or alternatively clamps onto a smooth rod using a set screw, compression collar, or other retention mechanism. When tightened against the tapered centering nuts or against the flange face, the compression nut 26 generates axial preload that prevents the connector rod 20 from sliding longitudinally relative to the flange mounting assembly.

The compression nut 26 may take various forms including a standard hex nut requiring a wrench for tightening, a wing nut with protruding handles for tool-free operation, a knurled nut with textured circumference for improved grip, or a quick-release lever mechanism for rapid engagement and disengagement. Wing nut and quick-release configurations prove advantageous in field applications where workers wear gloves or require frequent repositioning of the tool on different flanges. Hex nut configurations provide maximum tightening torque and resistance to loosening from vibration.

Some embodiments incorporate locking features within the compression nut 26 to prevent loosening during operation. These features include nylon insert lock nuts with a deformable polymer ring that creates friction against the threads, prevailing-torque all-metal lock nuts with deformed threads that increase breakaway torque, or mechanical lock washers positioned beneath the nut to resist rotation. Chemical thread-locking compounds applied to the threads before assembly provide another approach, though this reduces convenience for repositioning.

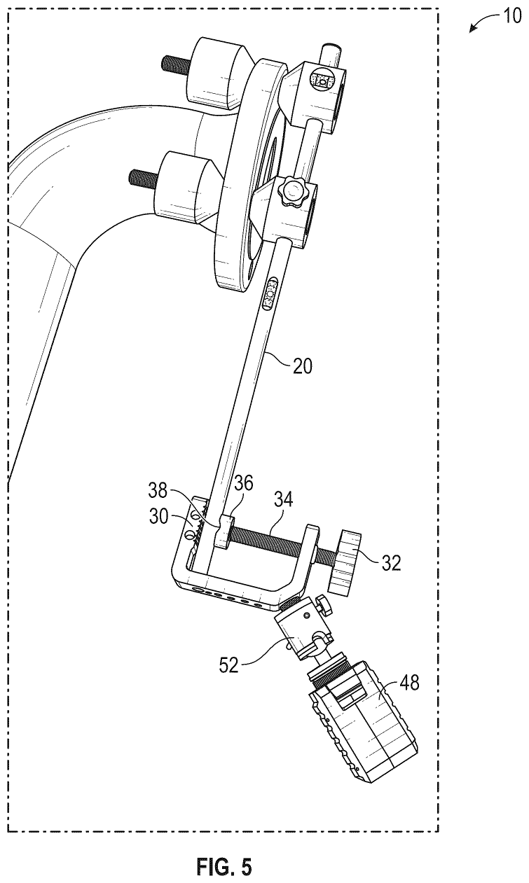

FIGS. 1 and 4 provides detailed views of the tapered centering nuts 12A, 12B, 12C, and 12D, showing their precise conical configuration and integrated leveling capabilities. Each nut's tapered outer surface forms a frustum of a cone, with the smaller diameter at the insertion end and larger diameter at the flange-facing end. This orientation ensures that as the nut advances into a bolt hole 16, the increasing diameter creates progressively tighter contact with the hole wall, generating the wedging action that centers and secures the nut.

The taper angle, measured between the conical surface and the central axis, typically ranges from 15 to 45 degrees. Steeper angles near 45 degrees create stronger self-centering action and higher clamping multiplication, where axial force on the nut translates to significantly higher radial force against the bolt hole wall. Shallower angles near 15 degrees reduce the clamping multiplication but permit the nut to seat deeper into the hole and accommodate wider tolerance variations in hole diameter. Many embodiments employ a 30-degree taper as a balanced compromise between centering effectiveness and tolerance accommodation.

The through-bore 18 extends concentrically through each nut along its central axis, maintaining constant diameter from end to end in the basic configuration. The bore diameter exceeds the connector rod 20 diameter by a clearance margin, typically 0.010 to 0.030 inches, sufficient to permit free sliding assembly while minimizing radial play that could introduce positioning error. Closer clearances increase positioning accuracy but require tighter manufacturing tolerances and create assembly difficulty if the rod develops surface scratches or contamination. Looser clearances simplify assembly and tolerate minor rod damage but allow greater positional variation.

The bubble level 44 integrates into tapered centering nut 12B, providing immediate visual indication of the nut's orientation relative to the horizontal plane. The bubble level typically comprises a sealed vial partially filled with liquid and containing an air bubble, with curved internal surfaces that cause the bubble to migrate to the highest point. When the vial orients level, the bubble centers within graduated markings, indicating proper orientation. The level may mount in a machined recess in the nut body, adhesively bond to an external surface, or integrate into the nut structure during casting or molding.

Additional bubble levels 46 and 48 may position on other system components including additional tapered nuts, the yoke bracket 30, the laser housing mounting interface, or the connector rod 20. Multiple levels oriented in different planes enable comprehensive leveling verification, with some indicating level in the horizontal plane, others indicating plumb in the vertical plane, and still others indicating angular relationships at specific designed orientations.

The yoke bracket 30 positions at the laser mounting end of the connector rod 20, creating the structural and kinematic interface between the fixed rod and the rotatable laser housing 28. The bracket 30 forms a C-shaped or U-shaped channel that opens on one side to permit lateral assembly onto the rod without requiring axial threading. The channel width slightly exceeds the rod diameter, creating a clearance gap that permits the rod to sit within the channel while allowing controlled rotational movement of the housing.

The yoke bracket 30 manufactures from aluminum for lightweight applications, steel for maximum strength and rigidity, or composite materials for corrosion resistance and non-magnetic properties. Wall thickness ranges from ⅛ inch to ¼ inch depending on the material and loading requirements. Surface finishing includes anodizing for aluminum, powder coating or plating for steel, or molded finishes for composites.

The bracket geometry incorporates mounting features for the laser housing 28, including bolt holes, threaded inserts, dovetail slots, or rail interfaces depending on the specific housing attachment method. The shoe track 50 shown in FIG. 1 represents one attachment approach, while the ball-head tilt mount 52 shown in FIG. 5 represents an alternative providing additional angular adjustment capability beyond simple rotation.

FIG. 5 depicts the complete yoke bracket assembly 30 with all clamping mechanism components visible. The manual actuator 32 provides the operator interface for engaging and disengaging the clamping function. In the configuration shown, the actuator comprises a hand wheel with a knurled or ribbed circumference to enhance grip. The wheel diameter typically ranges from 1.5 to 3 inches, sized for comfortable one-handed operation while providing sufficient mechanical advantage for generating adequate clamping force without excessive effort.

The actuator 32 couples rotatably to the yoke bracket 30 through a bearing, bushing, or threaded boss that permits rotation while preventing axial movement. A thrust bearing between the actuator and bracket reduces turning effort and prevents binding under clamping load. The actuator connects to the threaded adjustment shaft 34 through a coupling that may take several forms: direct mounting with the shaft extending through the actuator center, a hex socket that engages a hex section on the shaft end, or a splined connection for higher torque capacity.

The threaded adjustment shaft 34 extends from the actuator interface, through the yoke bracket body, and terminates at the clamping head 36. The shaft incorporates external threads along at least a portion of its length, with these threads engaging internal threads in the bracket or in an intermediate nut component. The thread pitch determines the clamping force multiplication and adjustment sensitivity, with finer pitches providing greater mechanical advantage and more precise positioning at the cost of requiring more actuator rotation per unit of clamping head travel. Common thread specifications include ¼-20, 5/16-18, or ⅜-16, though metric threads or specialized fine-pitch threads suit specific applications.

As the actuator 32 rotates in the tightening direction, typically clockwise when viewed from the actuator side, the threaded engagement causes the adjustment shaft 34 to advance linearly toward the connector rod 20. This advancement continues until the clamping head 36 contacts the rod, then builds clamping force as additional rotation increases thread tension. The mechanical advantage of the thread, combined with the actuator diameter, determines how much clamping force results from a given manual input torque. Properly designed systems enable operators to generate a predetermined number of pounds of clamping force with reasonable hand effort, sufficient to prevent housing rotation under operational loads while permitting deliberate repositioning when needed.

The clamping head 36 attaches to the terminal end of the threaded adjustment shaft 34, forming the physical contact interface with the connector rod 20. The head typically comprises a block or pad of metal or hard polymer, sized to provide adequate contact area while maintaining compact dimensions that minimize interference with adjacent components. The attachment to the shaft may use threading, with the head screwing onto threaded shaft end, or mechanical fastening with bolts, pins, or set screws securing the head to the shaft.

The contoured engagement surface 38 forms the actual contact interface between the clamping head 36 and the connector rod 20. For cylindrical rods, the engagement surface typically incorporates a V-groove, curved recess, or cradle geometry that mates with the rod's circular cross-section. V-groove configurations create two line contacts along the edges of the groove, concentrating clamping force at these lines while permitting the rod to nest into the groove for positive positioning. Curved recess configurations create broader area contact that distributes clamping pressure over a larger surface, reducing contact stress and minimizing potential for marring the rod finish.

The groove or recess depth affects the contact geometry and clamping effectiveness. Shallow grooves, typically 10-20% of the rod diameter, create acute contact angles that increase the tangential force component resisting rotation. Deeper grooves approaching 50% of rod diameter create more obtuse contact angles but provide better centering and reduce the tendency for the rod to climb out of the groove under side loading. Most embodiments employ groove depths of 20-30% of rod diameter as a practical compromise.

The engagement surface 38 may incorporate features to enhance grip without damaging the rod. These include knurling or serrations that bite into the rod surface, elastomeric pads or inserts that increase friction through material properties, or hardened inserts that resist wear during repeated clamping cycles. Some designs use replaceable contact pads, allowing periodic replacement as wear occurs without requiring clamping head replacement.

The laser housing 28 serves as the protective enclosure for a commercial laser projection unit while providing the mechanical interface for rotational adjustment relative to the mounting bracket. The housing typically forms an elongated box, cylinder, or irregular shape dimensioned to accommodate standard off-the-shelf laser units commonly available for construction and alignment applications. The housing protects the internal laser unit from impact, moisture, dust, and other environmental contaminants encountered in industrial field environments.

Housing construction employs impact-resistant materials capable of withstanding the mechanical abuse common in oil and gas operations. Polycarbonate provides excellent impact resistance, moderate cost, and adequate environmental protection for most applications. Aluminum offers superior heat dissipation, electromagnetic shielding, and premium durability for harsh environments. Glass-filled nylon or other engineering polymers balance performance and cost for mid-range applications. The housing exterior incorporates optical windows or openings through which the laser beam emits, with these openings either left open or covered with transparent protective materials.

The housing mounts to the yoke bracket 30 through the shoe track 50 shown in FIG. 1 or through the ball-head tilt mount 52 shown in FIG. 5. The shoe track 50 comprises a dovetail rail, T-slot rail, or similar linear guide attached to the yoke bracket 30, with the laser housing 28 incorporating a mating groove or channel that slides onto the rail. This rail interface provides secure mounting while permitting controlled sliding along the rail axis for position adjustment or removal. The shoe track configuration maintains a fixed angular relationship between the housing and bracket, with rotation occurring about the connector rod axis as the entire bracket-and-housing assembly rotates when the clamping mechanism releases.

The bubble level 48 integrates into the shoe track 50 or into the laser housing mounting interface, providing immediate visual indication of the housing orientation. This level assists operators in verifying that the laser line projects horizontally, vertically, or at other desired angles relative to gravity. The level may mount directly to the shoe track body, integrate into the housing structure adjacent to the track interface, or attach to the yoke bracket near the track mounting location.

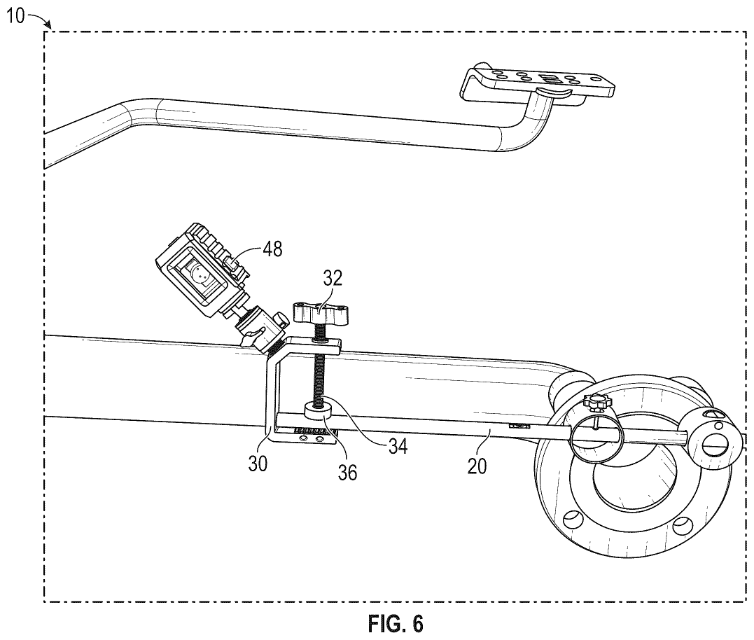

FIGS. 1 and 6 shows the complete laser alignment tool 10 mounted on a flange assembly in full operational configuration. The tapered centering nuts secure in the flange bolt holes, establishing the rigid mounting foundation. The connector rod 20 extends from the flange mounting assembly, projecting outward to position the laser housing 28 at an appropriate standoff distance for projection operations. The yoke bracket 30 and clamping mechanism support the laser housing 28 and enable rotational adjustment as needed for alignment tasks.

In this embodiment, the laser housing 28 couples to the yoke bracket 30 through a ball-head tilt mount 52 rather than the shoe track 50 illustrated in FIG. 1. The ball-head tilt mount 52 provides multiple degrees of rotational freedom, enabling the laser housing to tilt, pan, and rotate relative to the bracket. This multi-axis adjustment proves valuable for complex alignment scenarios where the laser line must project at angles not perpendicular to the flange face, or where the flange itself installs at an angle requiring compensating adjustment of the laser orientation.

The ball-head mechanism typically comprises a spherical joint with a locking collar or lever that clamps the sphere when tightened and releases it for adjustment when loosened. The sphere may integrate directly into the laser housing structure, or the housing may bolt to a ball-and-socket adapter that then mounts to the yoke bracket. Ball-head mounts provide rapid, intuitive adjustment of multiple angles simultaneously through a single locking control, though they sacrifice the precise indexed positioning that fixed-geometry mounts provide.

The ball-head tilt mount 52 may position at various locations along the yoke bracket 30 length, with the optimal position balancing stability against adjustment convenience. Mounting near the bracket center places the ball joint close to the connector rod centerline, minimizing the moment arm and reducing the required clamping force to resist housing rotation. Mounting offset from the bracket center increases the moment arm but may position the ball joint and its locking control in a more accessible location for operator adjustment.

The laser housing 28 contains a self-contained commercial laser unit that generates the visible laser line used for alignment reference. These commercial units are available from multiple manufacturers and typically incorporate integrated power supplies, optical systems, and environmental protection suitable for industrial field use. The housing 28 secures the laser unit and provides the mechanical interface to the mounting bracket through either the shoe track 50 or ball-head tilt mount 52 configuration.

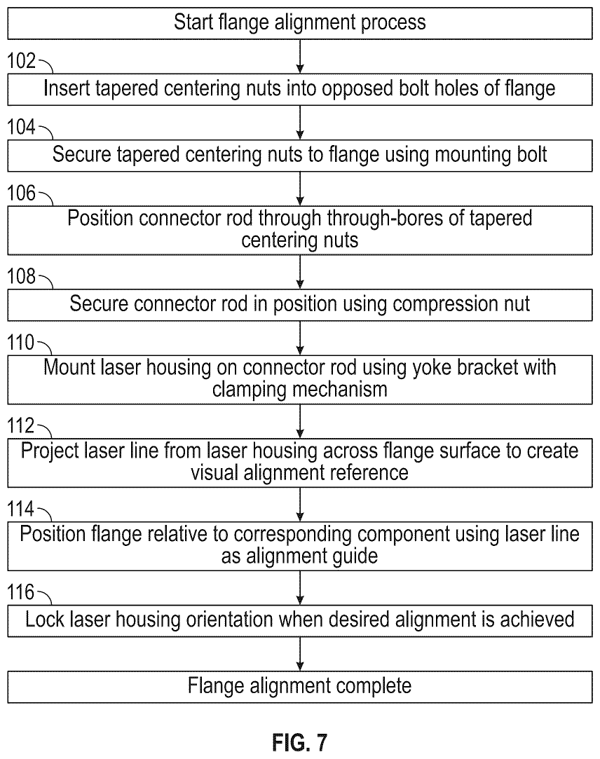

FIGS. 1 and 7 collectively illustrate a method for aligning a flange using the laser alignment tool 10. The method proceeds through a sequence of installation and alignment operations that position the tool on the flange, configure the laser projection system, and establish visual alignment references for flange positioning.

Step 102 involves inserting tapered centering nuts 12A, 12B, 12C, and 12D into opposed bolt holes 16 of a flange 22, with each tapered centering nut having a through-bore 18. The insertion process begins with selecting appropriate bolt holes 16 on the flange 22 that provide optimal geometric support for the alignment operation. For a four-bolt-hole flange, two pairs of diametrically opposed holes are typically selected, with each pair positioned 90 degrees from the other pair. The operator grasps each tapered centering nut and inserts its smaller-diameter end into the selected bolt hole 16, advancing the nut until the tapered outer surface 14 engages the cylindrical wall of the hole. As the nut advances, the increasing taper diameter creates progressively tighter contact with the hole wall, generating the wedging action that centers and secures the nut within the hole. The insertion continues until the nut seats firmly, with its larger-diameter end adjacent to the flange face. This process repeats for each of the four nuts, positioning nuts 12A and 12B in one diametrically opposed pair and nuts 12C and 12D in the perpendicular opposed pair.

Step 104 involves securing the tapered centering nuts 12A, 12B, 12C, and 12D to the flange 22 using the mounting bolt 24. The operator takes the mounting bolt 24 and inserts it through the through-bore 18 of one nut in an opposed pair, for example nut 12A. The bolt extends across the central opening of the flange 22 and into the through-bore 18 of the opposed nut 12B. If nut 12A contains internal threads, the operator rotates the bolt to engage these threads, advancing the bolt until it achieves sufficient engagement depth. The operator then applies tightening torque to the mounting bolt 24, rotating it in the tightening direction. This rotation generates axial tension in the bolt that pulls nuts 12A and 12B toward one another across the flange thickness. The tightening process continues until adequate clamping force develops to lock the nuts securely to the flange structure. The operator repeats this securing process for the second opposed pair of nuts 12C and 12D using a second mounting bolt 24, creating a rigid four-point mounting platform attached to the flange.

Step 106 involves positioning the connector rod 20 through the through-bores 18 of the tapered centering nuts 12A, 12B, 12C, and 12D. The operator grasps the connector rod 20 and aligns one end with the through-bore openings of the secured tapered centering nuts. The rod advances through the first nut, continues across the flange central opening, and passes through the remaining nuts until it extends through all four aligned through-bores 18. The circular cross-section of the rod and the cylindrical geometry of the through-bores permit smooth insertion with minimal resistance when properly aligned. The operator advances the rod to the desired position, typically positioning it to extend a specific distance beyond the last nut to provide appropriate standoff for the laser housing mounting.

Step 108 involves securing the connector rod 20 in position using the compression nut 26. After positioning the connector rod 20 at the desired location relative to the tapered centering nuts, the operator takes the compression nut 26 and threads it onto the connector rod 20 at the flange mounting end. If the rod features external threads, the compression nut engages these threads and advances along the rod as the operator rotates it. The operator tightens the compression nut until it bears against the adjacent tapered centering nut or against the flange face, generating axial preload that prevents the connector rod 20 from sliding longitudinally. The tightening continues until sufficient friction develops between the nut and rod to resist operational loads and vibration that might otherwise cause unwanted rod movement.

Step 110 involves mounting the laser housing 28 on the connector rod 20 using the yoke bracket 30 with the clamping mechanism. The operator positions the yoke bracket 30 onto the connector rod 20 at the laser mounting end, sliding the rod into the C-shaped or U-shaped channel of the bracket. The laser housing 28, preassembled to the yoke bracket through either the shoe track 50 interface or the ball-head tilt mount 52, positions on the connector rod along with the bracket. Alternatively, the operator may first mount the bracket to the rod, then attach the laser housing to the bracket through the appropriate mounting interface. With the housing and bracket assembly positioned on the rod, the operator manipulates the manual actuator 32 to engage the clamping mechanism. If the clamping mechanism is initially loosened, the operator rotates the actuator in the tightening direction, causing the threaded adjustment shaft 34 to advance the clamping head 36 toward the connector rod 20 until the contoured engagement surface 38 contacts the rod and generates sufficient clamping force to support the laser housing weight while permitting deliberate rotational adjustment.

Step 112 involves projecting the laser line 42 from the laser housing 28 across a flange surface to create a visual alignment reference. The operator activates the laser unit contained within the laser housing 28, typically by operating a power switch, button, or control on the housing exterior. Upon activation, the laser unit generates a coherent beam that emits through the housing's optical window or aperture, creating the visible laser line 42 that extends across the work area. The line projects across the flange face, continues beyond the flange periphery, and extends to the target alignment location where a corresponding component such as an elbow, valve, or mating flange requires positioning. The projected line provides a visual reference that indicates the current orientation of the flange relative to the desired alignment position. If the laser unit generates a cross-pattern, two perpendicular lines project simultaneously, providing alignment reference in two orthogonal directions.

Step 114 involves positioning the flange 22 relative to a corresponding component using the laser line 42 as an alignment guide. With the laser line projecting across the work area, the operator observes where the line intersects the target component or alignment location. The operator manipulates the flange orientation and position, typically using lifting equipment, positioning fixtures, or manual force, adjusting the flange location and angular orientation until the projected laser line 42 aligns with the desired reference marks, features, or geometry on the target component. This positioning process may involve translation of the flange in multiple directions, rotation about various axes, or combination movements to achieve proper alignment. As the flange moves, the laser line moves correspondingly, providing continuous visual feedback regarding alignment status. The operator continues adjustments until the laser line indicates that the flange has achieved the correct position and orientation relative to the target component. During this positioning process, the operator may rotate the laser housing 28 about the connector rod 20 to orient the laser line at different angles, facilitating alignment verification from multiple perspectives or accommodating complex geometric relationships between the flange and target component.

Step 116 involves locking the laser housing 28 orientation when desired alignment is achieved. Once the flange 22 has been positioned to achieve the desired alignment as indicated by the laser line 42, the operator tightens the clamping mechanism to lock the laser housing 28 in its current rotational orientation. The operator rotates the manual actuator 32 in the tightening direction, causing the threaded adjustment shaft 34 to advance the clamping head 36 with increasing force against the connector rod 20. The contoured engagement surface 38 presses against the rod with sufficient force to prevent rotation of the laser housing relative to the rod, locking the laser line orientation. With the housing locked, the laser line maintains its angular position throughout subsequent operations including final flange positioning verification, bolt installation, and tightening procedures. The locked configuration ensures that the alignment reference remains stable and repeatable during the completion of the installation process.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

In this description, for purposes of explanation and not limitation, specific details are set forth, such as particular embodiments, procedures, techniques, etc. in order to provide a thorough understanding of the present disclosure. However, it will be apparent to one skilled in the art that the present disclosure may be practiced in other embodiments that depart from these specific details.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

What is claimed is:

1. A laser alignment tool for flange fit-up, comprising:
a plurality of tapered centering nuts, each tapered centering nut having a tapered outer surface sized to seat in a flange bolt hole and a through-bore sized to slidably receive a connector rod;
a mounting bolt extending through opposed tapered centering nuts of the plurality of tapered centering nuts and configured, when tightened, to draw the opposed tapered centering nuts toward one another;
a connector rod extending through the through-bores of the plurality of tapered centering nuts;
a compression nut engaged with the connector rod at a flange mounting end and operable to prevent sliding of the connector rod relative to the plurality of tapered centering nuts;
a yoke bracket positioned at a laser mounting end of the connector rod;
a manual actuator rotatably coupled to the yoke bracket;
a threaded adjustment shaft extending from the manual actuator through the yoke bracket;
a clamping head attached to the threaded adjustment shaft and having a contoured engagement surface configured to interface with the connector rod;
a laser housing carried by the yoke bracket and rotatable relative to the connector rod when the clamping head is disengaged; and
a laser projection system disposed within the laser housing and configured to emit a visible laser line across a flange surface.

2. The laser alignment tool of claim 1, wherein one of the tapered centering nuts includes an integrated leveling indicator.

3. The laser alignment tool of claim 1, wherein the laser housing is configured to rotate 360 degrees about the connector rod when the clamping head is disengaged.

4. The laser alignment tool of claim 1, wherein the contoured engagement surface of the clamping head includes a curved recess configured to grip the connector rod.

5. The laser alignment tool of claim 1, wherein the laser projection system includes a high-visibility green laser diode.

6. The laser alignment tool of claim 1, wherein the laser housing comprises a polycarbonate housing configured to withstand harsh industrial conditions.

7. The laser alignment tool of claim 1, wherein the laser housing includes integrated leveling indicators for verifying proper alignment.

8. The laser alignment tool of claim 1, wherein the connector rod comprises a forged steel rod having a half-inch diameter.

9. The laser alignment tool of claim 1, wherein the clamping head is configured to create a locking interface that prevents both sliding and rotation of the connector rod when engaged.

10. A flange alignment apparatus, comprising:
a flange mounting assembly including tapered centering nuts sized to engage flange bolt holes and a mounting bolt configured to secure the tapered centering nuts to a flange;
a support rod extending from the flange mounting assembly;
a laser mounting assembly positioned on the support rod and including a bracket assembly with a clamping mechanism operable to selectively lock and release rotational movement of a laser housing;
the laser housing rotatably supported by the laser mounting assembly;
a laser source within the laser housing configured to project a coherent beam for flange alignment; and
wherein disengaging the clamping mechanism permits 360-degree rotation of the laser housing relative to the support rod.

11. The flange alignment apparatus of claim 10, wherein the bracket assembly includes a U-shaped configuration that partially surrounds the support rod.

12. The flange alignment apparatus of claim 10, wherein the clamping mechanism includes a manual actuator and threaded shaft arrangement.

13. The flange alignment apparatus of claim 10, further comprising a bubble level integrated into the flange mounting assembly.

14. The flange alignment apparatus of claim 10, wherein the laser source is battery operated for portability in field applications.

15. The flange alignment apparatus of claim 10, wherein the laser mounting assembly permits limited angular adjustment in addition to 360-degree rotation.

16. A method for aligning a flange, comprising:
inserting tapered centering nuts into opposed bolt holes of a flange, each tapered centering nut having a through-bore;
securing the tapered centering nuts to the flange using a mounting bolt;
positioning a support rod through the through-bores of the tapered centering nuts;
securing the support rod in position using a compression mechanism;
mounting a laser housing on the support rod using a bracket assembly with a clamping mechanism;
projecting a laser line from the laser housing across a flange surface to create a visual alignment reference;
positioning the flange relative to a corresponding component using the laser line as an alignment guide; and
locking the laser housing orientation when desired alignment is achieved.

17. The method of claim 16, further comprising rotating the laser housing 360 degrees about the support rod to orient the laser line at a desired angle.

18. The method of claim 16, further comprising verifying proper leveling using an integrated leveling indicator before projecting the laser line.

19. The method of claim 16, further comprising adjusting an angular position of the laser housing to accommodate non-square flange alignments.

20. The method of claim 16, wherein projecting the laser line includes operating a battery-powered laser source for field portability.
